(19) United States
(12) Patent Application Publication
(10) Pub. No.: US 2026/0250992 A1
(43) Pub. Date: Aug. 27, 2026

(54) DOOR LOCK DEVICE

(71) Applicant: AISIN CORPORATION, Kariya (JP)

(72) Inventors: Ryu GOTO, Kariya-shi (JP); Ryo ASANO, Kariya-shi (JP)

(73) Assignee: AISIN CORPORATION, Kariya (JP)

(21) Appl. No.: 19/548,331

(22) Filed: Feb. 24, 2026

(30) Foreign Application Priority Data
Feb. 26, 2025 (JP) 2025-028749

(51) Int. Cl. E05B 81/56; E05B 81/06; E05B 81/16; E05B 81/18; E05B 81/30

(52) U.S. Cl. CPC E05B 81/56; E05B 81/06; E05B 81/16; E05B 81/18; E05B 81/30

(57) ABSTRACT

A door lock device for a vehicle includes: a latch mechanism selectively forming a latched state in which a door is held in a closed state, and an unlatched state in which opening of the door is allowed; a lock mechanism selectively forming a locked state in which switching of the latch mechanism to the unlatched state by manual operation is prohibited, and an unlocked state in which the switching of the latch mechanism to the unlatched state by manual operation is allowed; a double lock mechanism selectively forming a double lock set state in which switching of the lock mechanism to the unlocked state is prohibited, and a double lock unset state in which the switching of the lock mechanism to the unlocked state is allowed; a first actuator electrically switching the lock mechanism to the unlocked state; a second actuator electrically switching the latch mechanism to the unlatched state regardless of a state of the lock mechanism and a state of the double lock mechanism; a third actuator electrically switching the double lock mechanism to the double lock unset state; and a control device controlling the first actuator, the second actuator, and the third actuator to switch the double lock mechanism to the double lock unset state and switch the lock mechanism to the unlocked state after switching the latch mechanism to the unlatched state upon detecting a door opening operation by an authenticated operator when the lock mechanism is in the locked state and the double lock mechanism is in the double lock set state.

### CROSS REFERENCE TO RELATED APPLICATIONS

This application is based on and claims priority under 35 U.S.C. § 119 to Japanese Patent Application No. 2025-028749, filed on Feb. 26, 2025, the entire content of which is incorporated herein by reference.

### TECHNICAL FIELD

The present specification discloses a door lock device.

### BACKGROUND DISCUSSION

As this type of conventional door lock device, a door lock device has been proposed that includes a lock/unlock device including a lock/unlock mechanism and a double lock mechanism, a transmitter that transmits an ID request, a receiver that receives an answer ID, an object detection sensor that detects approach of a person to the lock/unlock device, and a control device that controls the lock/unlock device (see, for example, JP 2000-45592 A). When receiving a registered ID transmitted in response to the ID request from a portable device carried by a user, the control device releases a double-locked state of the lock/unlock device. When detecting approach of a person to the lock/unlock device, the control device unlocks the lock/unlock device. As a result, unlocking can be completed before the user operates a handle.

In the door lock device described in JP 2000-45592 A, approach of the portable device to a vehicle is used as a trigger for releasing the double lock. Therefore, depending on the location of a parking area and a home or the like, a distance between the portable device placed at the home or the like and the vehicle may be short, and the double lock may be unintentionally released. In the door lock device described in JP 2000-45592 A, it is necessary to operate the double lock mechanism prior to an opening operation of a door by the user in order to immediately enable opening of the door by the opening operation of the door. For this reason, in a case where the opening operation of the door is not actually performed, the unnecessary operation leads to an increase in power consumption and a decrease in device durability.

A need thus exists for a door lock device which is not susceptible to the drawback mentioned above.

### SUMMARY

A door lock device for a vehicle, the door lock device includes: a latch mechanism configured to selectively form a latched state in which a door is held in a closed state, and an unlatched state in which opening of the door is allowed; a lock mechanism configured to selectively form a locked state in which switching of the latch mechanism to the unlatched state by manual operation is prohibited, and an unlocked state in which the switching of the latch mechanism to the unlatched state by manual operation is allowed; a double lock mechanism configured to selectively form a double lock set state in which switching of the lock mechanism to the unlocked state is prohibited, and a double lock unset state in which the switching of the lock mechanism to the unlocked state is allowed; a first actuator configured to electrically switch the lock mechanism to the unlocked state; a second actuator configured to electrically switch the latch mechanism to the unlatched state regardless of a state of the lock mechanism and a state of the double lock mechanism; a third actuator configured to electrically switch the double lock mechanism to the double lock unset state; and a control device configured to control the first actuator, the second actuator, and the third actuator to switch the double lock mechanism to the double lock unset state and switch the lock mechanism to the unlocked state after switching the latch mechanism to the unlatched state upon detecting an opening operation of the door by an authenticated operator when the lock mechanism is in the locked state and the double lock mechanism is in the double lock set state.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view illustrating a door of a vehicle where a door lock device of the present disclosure is mounted;

FIG. 2 is a schematic configuration view of the door lock device in an unlocked state;

FIG. 3 is a schematic configuration view of the door lock device in the unlocked state;

FIG. 4 is a schematic configuration view of the door lock device in a locked state and a double lock unset state;

FIG. 5 is a schematic configuration view of the door lock device in the locked state and the double lock unset state;

FIG. 6 is a schematic configuration view of the door lock device in a double lock set state;

FIG. 7 is a schematic configuration view of the door lock device in the double lock set state;

FIG. 8 is a schematic configuration view of the door lock device when an inside door handle is operated from the unlocked state;

FIG. 9 is a schematic configuration view of the door lock device when the inside door handle is operated from the unlocked state;

FIG. 10 is a schematic configuration view of the door lock device when a push-type cam mechanism is in an operating state;

FIG. 11 is a schematic configuration view of the door lock device when the push-type cam mechanism is in the operating state;

FIG. 12 is a schematic configuration view of the door lock device when the door lock device is switched from the double lock set state to an unlatched state by driving of a motor;

FIG. 13 is a schematic configuration view of the door lock device when the door lock device is switched from the double lock set state to the unlatched state by driving of the motor;

FIG. 14 is a control block diagram of the door lock device; and

FIG. 15 is a flowchart illustrating an example of an unlatch control routine.

### DETAILED DESCRIPTION

Next, an embodiment for carrying out the present disclosure will be described with reference to the drawings.

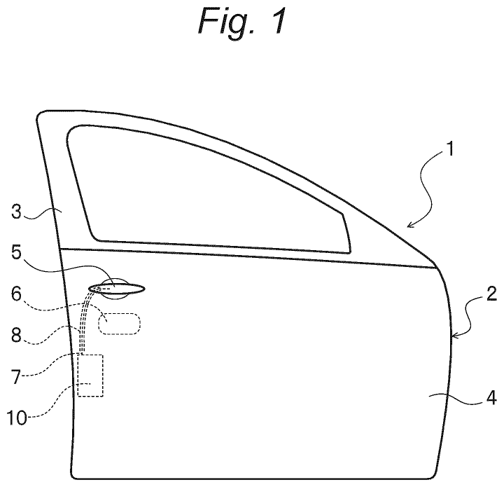

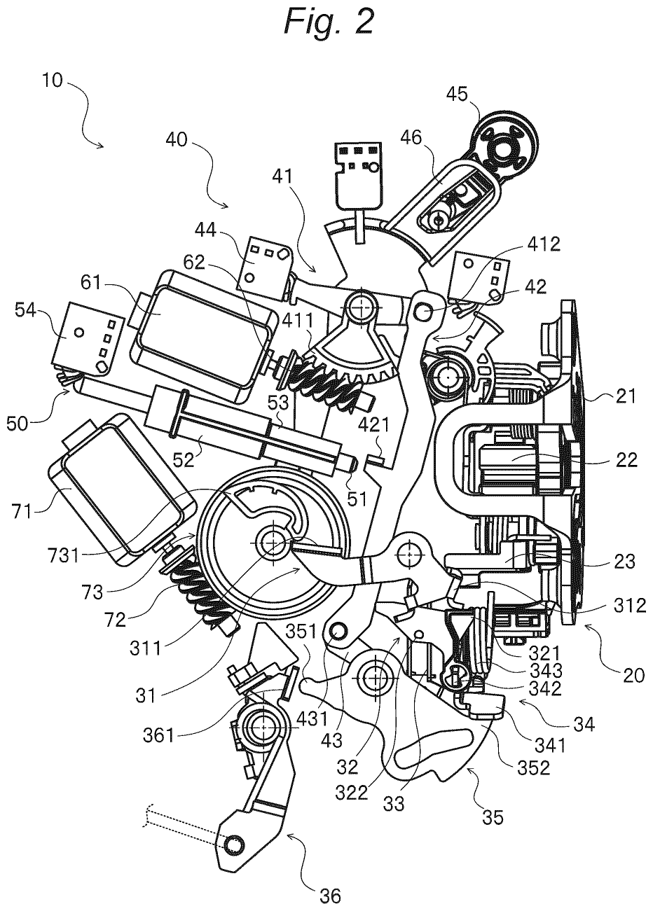

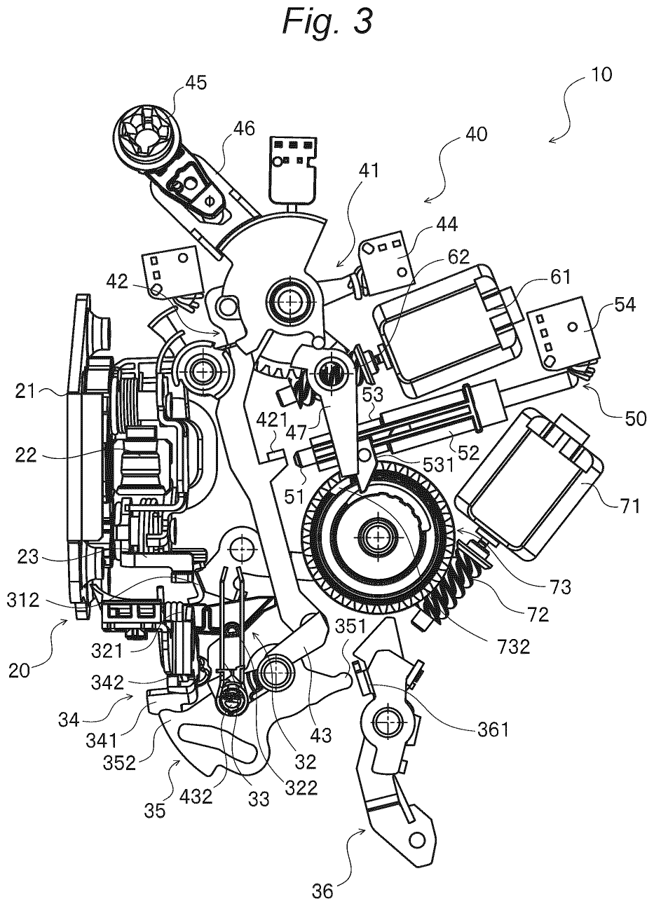

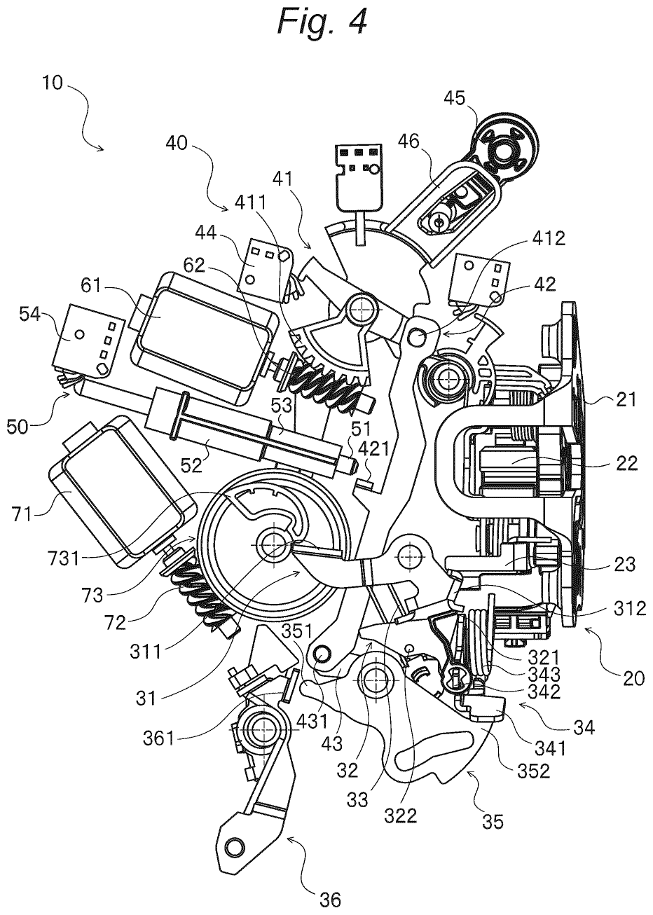

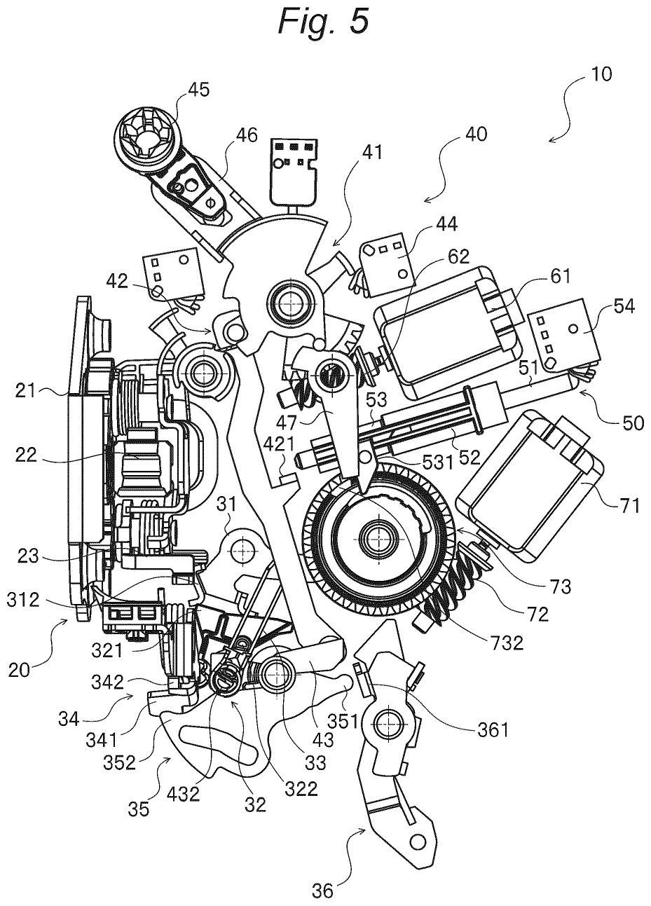

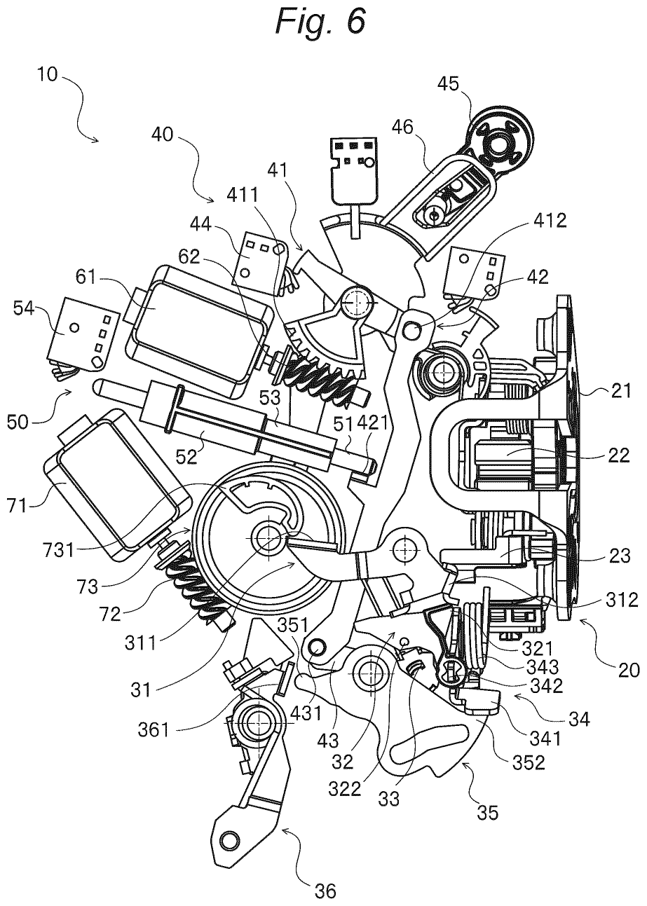

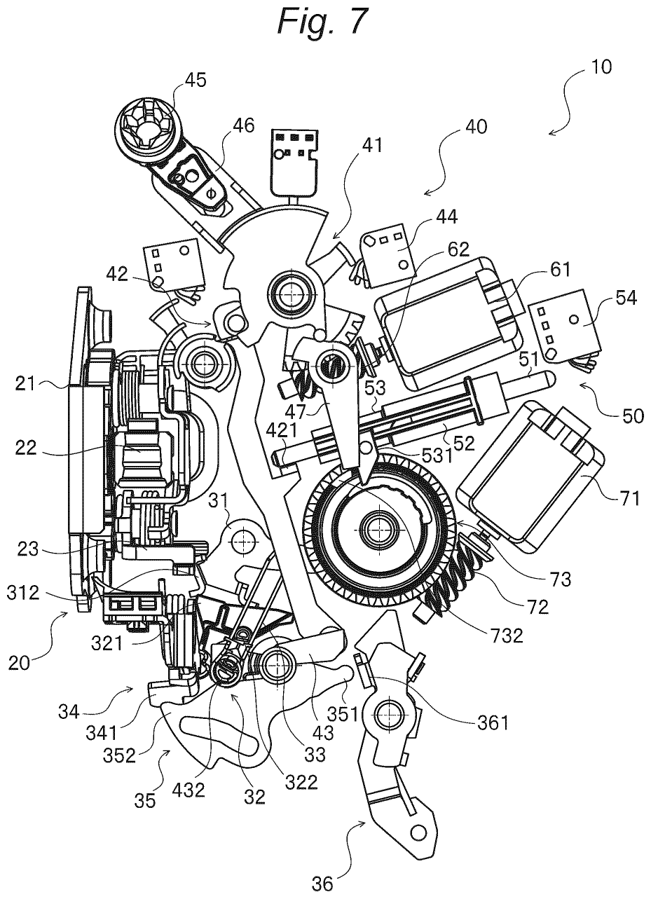

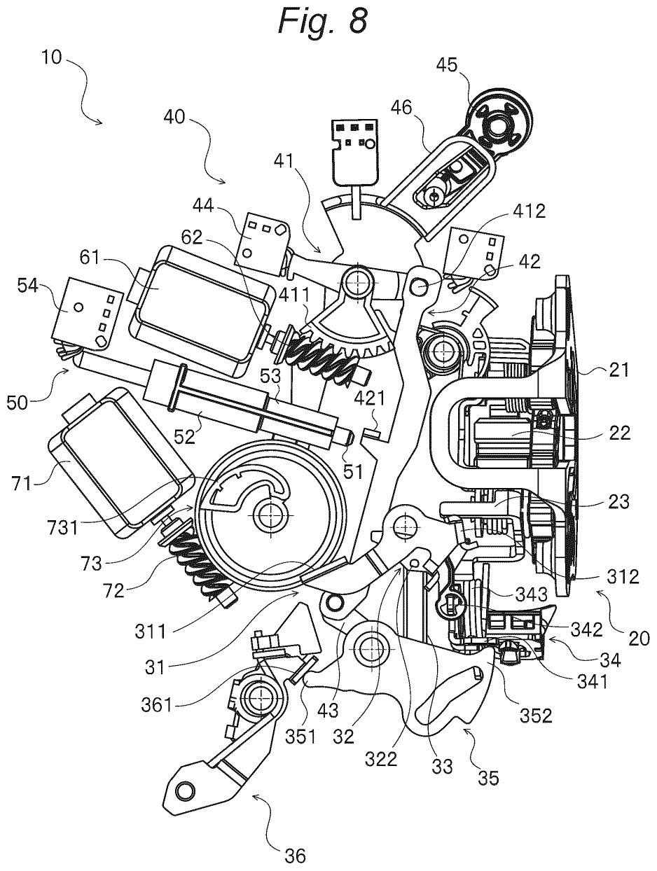

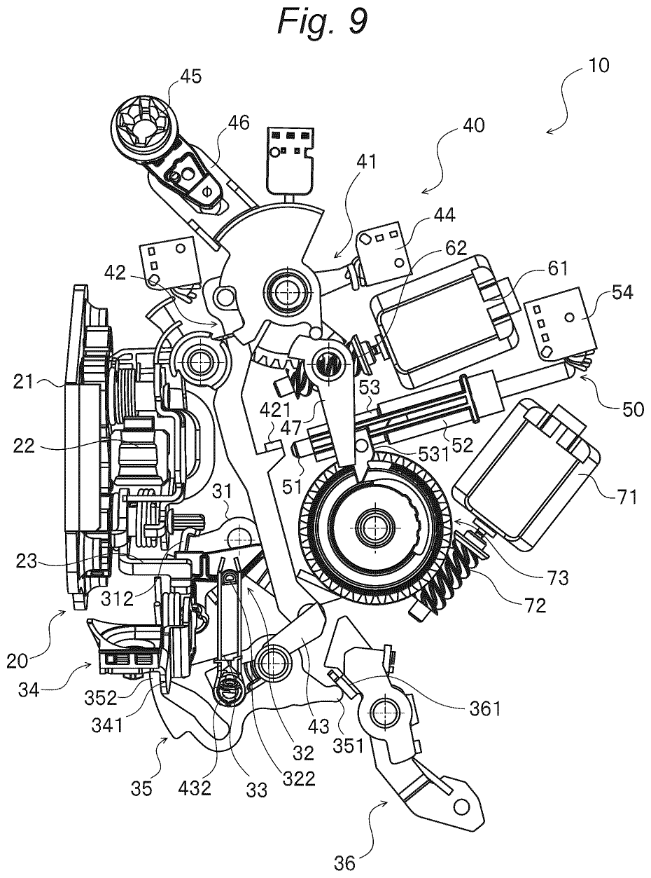

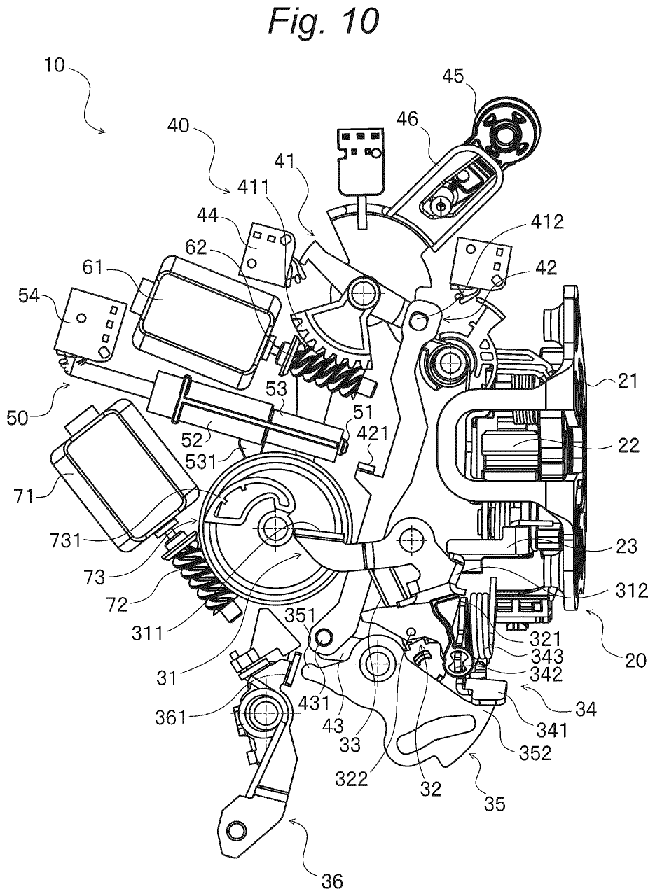

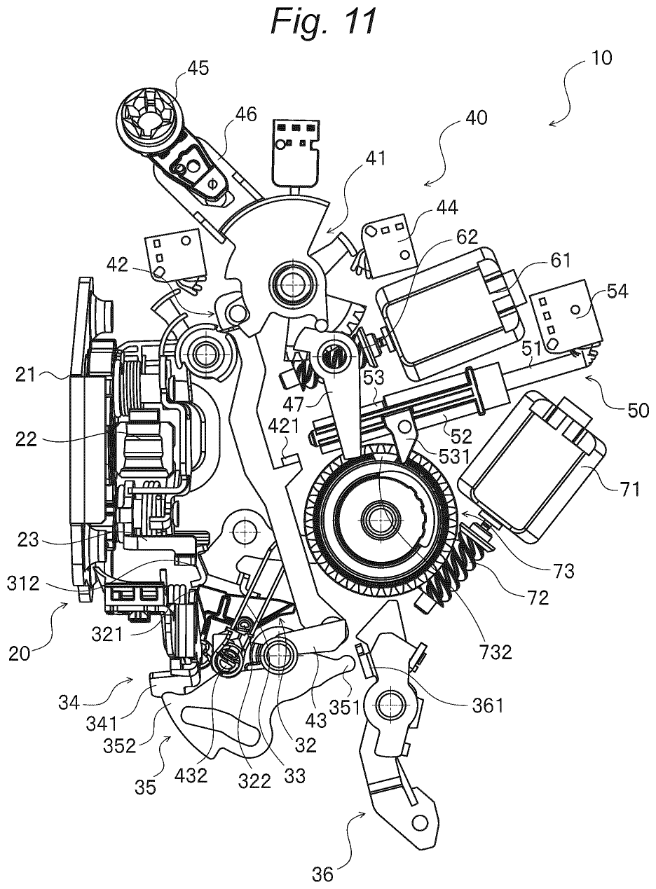

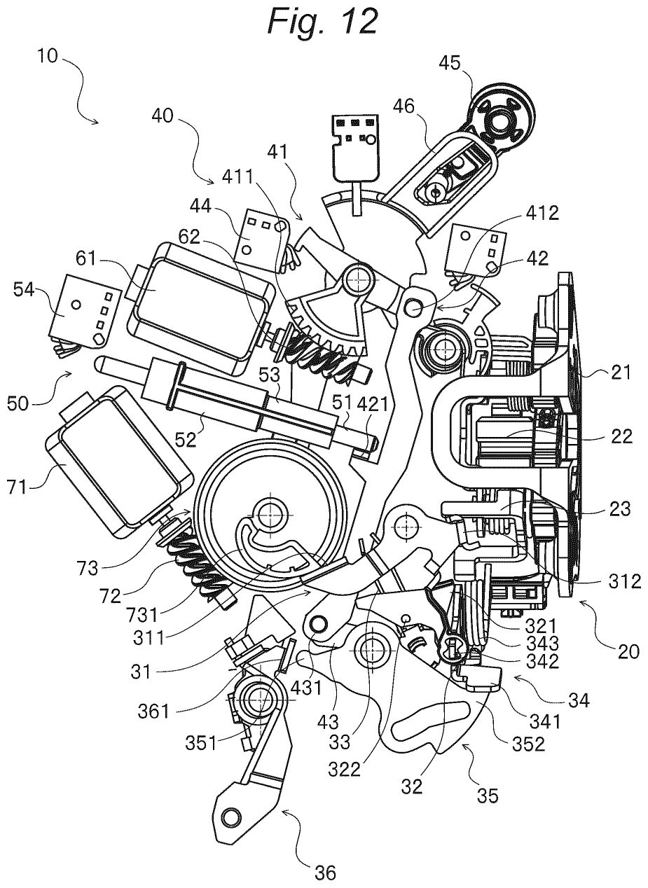

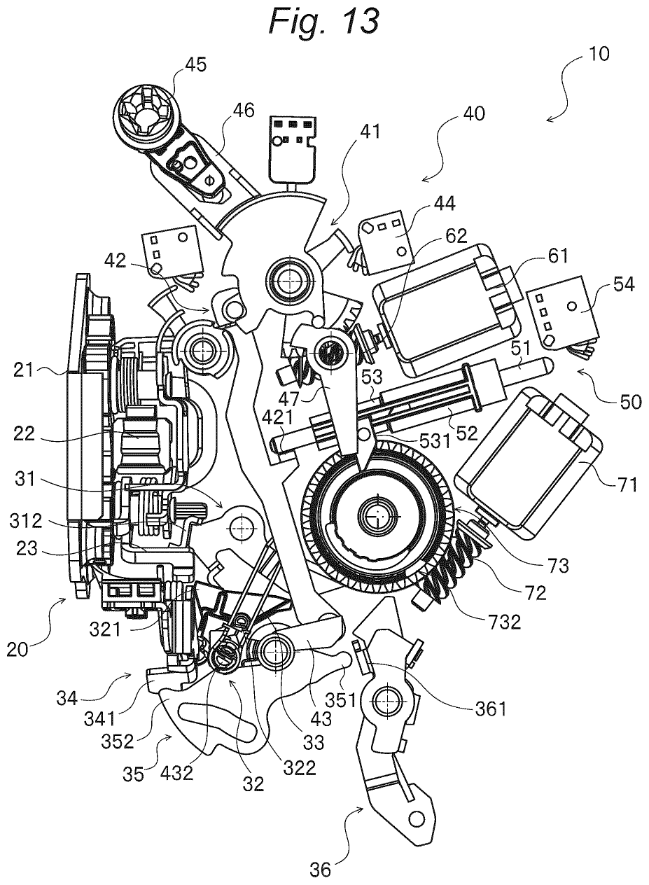

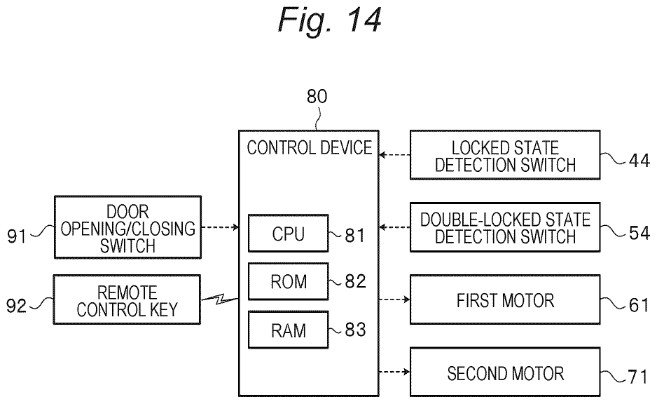

FIG. 1 is a schematic configuration view illustrating a door 1 of a vehicle where a door lock device 10 of the present disclosure is mounted. FIGS. 2 and 3 are schematic configuration views of the door lock device 10 in an unlocked state. FIGS. 4 and 5 are schematic configuration views of the door lock device 10 in a locked state and a double lock unset state. FIGS. 6 and 7 are schematic configuration views of the door lock device 10 in a double lock set state. FIGS. 8 and 9 are schematic configuration views of the door lock device 10 when an inside door handle 6 is operated from the unlocked state. FIGS. 10 and 11 are schematic configuration views of the door lock device 10 when a push-type cam mechanism is in an operating state. FIGS. 12 and 13 are schematic configuration views of the door lock device 10 when the door lock device 10 is switched from the double lock set state to an unlatched state by driving of a second motor 71. FIG. 14 is a control block diagram of the door lock device 10.

The door 1 is a front door of a driver's seat or a passenger seat of the vehicle, and includes a door body 2 forming a lower half portion of the door 1 and a door sash 3 forming an upper half portion of the door 1 and guiding a window glass as illustrated in FIG. 1. The door body 2 includes an outer panel 4, an inner panel (not illustrated) fixed to an inner side (vehicle interior side) of the outer panel 4, and a trim (not illustrated) made of resin fixed to a surface on the vehicle interior side of the inner panel. The door 1 is pivotable from a fully-closed position to a fully-open position through a half-open position (half-closed position), with its front end rotatably supported by a vehicle body (not illustrated) of the vehicle as a fulcrum. The half-open position is a position moved slightly toward the open position from the fully-closed position.

The door 1 also includes an outside door handle 5 attached to the outer panel 4 in a pullable or pivotable manner, and the inside door handle 6 attached to the trim in a pullable or pivotable manner. The outside door handle 5 and the inside door handle 6 are biased to initial positions by springs (not illustrated) or the like. A user of the vehicle can open the door 1 by manually operating the outside door handle 5 or the inside door handle 6 to move the outside door handle 5 or the inside door handle 6 from the initial position to a door open position. The door 1 may be a rear seat door, a panel door (press door), or a sashless door of the vehicle.

As illustrated in FIG. 1, the door lock device 10 is disposed in an internal space of the door 1 defined by the outer panel 4 and the inner panel (not illustrated). More specifically, the door lock device 10 is fixed to, for example, the inner panel so as to be located below the outside door handle 5 in the internal space. The door lock device 10 is connected to the outside door handle 5 through a cable (inner cable) 7 and an outer cylindrical member (outer casing) 8 each having flexibility. The cable 7 is inserted into the outer cylindrical member 8, and the cable 7 and the outer cylindrical member 8 transmit the movement of the outside door handle 5 from the initial position to the door open position to the door lock device 10.

As illustrated in FIGS. 2 to 13, the door lock device 10 includes a latch mechanism 20, a lock mechanism 40, a double lock mechanism 50, a first motor 61, the second motor 71, a rotating member 73, and a control device 80 (see FIG. 14) that controls the entire device.

The latch mechanism 20 is configured to be able to selectively form a fully-latched state in which the door 1 is held at the fully-closed position, a half-latched state in which the door 1 is held at the half-open position located slightly closer to the open side with respect to the fully-closed position, and an unlatched state in which opening of the door 1 is allowed. The fully-latched state and the half-latched state may be referred to as a latched state. The latch mechanism 20 includes a base plate 21, a latch 22, a lift lever 23, a release lever 31, an open link 32, an outside open lever 34, an inside lever 35, and an inside open lever 36.

The latch 22 includes a cutout portion (not illustrated) engageable with a striker (not illustrated) fixed to the vehicle body. The latch 22 is supported rotatably with respect to the base plate 21, and is movable to a fully-latched position, a half-latched position, and an unlatched position by rotation. In the fully-latched position, the striker of the vehicle body is held in the cutout portion of the latch 22, whereby the door 1 is held at the fully-closed position. In the half-latched position, the door 1 is held at the half-open position while the striker of the vehicle body is being held in the cutout portion of the latch 22. In the unlatched position, the striker is released from the cutout portion of the latch 22, and the opening of the door 1 is allowed.

The latch 22 is biased in a direction of releasing the striker by a latch spring (not illustrated). The latch 22 is held at the fully-latched position or the half-latched position by the lift lever 23 restricting rotation in the direction of releasing the striker at the fully-latched position or the half-latched position.

The lift lever 23 is supported rotatably with respect to the base plate 21, and is selectively movable to an initial position and an operating position by rotation. When located at the initial position, the lift lever 23 restricts the rotation of the latch 22 in the direction of releasing the striker. On the other hand, when moving to the operating position, the lift lever 23 releases the restriction on the rotation of the latch 22 in the direction of releasing the striker. As a result, the latch 22 is moved to the unlatched position by the latch spring to release the striker, so that the door 1 can be opened.

The release lever 31 is supported rotatably with respect to a housing (not illustrated) of the door lock device 10, and is selectively movable to an initial position and an operating position by rotation. When located at the initial position, the release lever 31 locates the lift lever 23 at the initial position. When moving to the operating position, the release lever 31 presses the lift lever 23 to move the lift lever 23 to the operating position. The release lever 31 includes a rotating member engagement portion 311 and a lift lever engagement portion 312.

The open link 32 is supported rotatably with respect to the outside open lever 34. Therefore, the open link 32 is relatively rotatable with respect to the outside open lever 34 and is movable integrally with the outside open lever 34. The open link 32 is movable to an unlocked position (see FIGS. 2 and 3) and a locked position (see FIGS. 4 and 5) by relatively rotating with respect to the outside open lever 34. Furthermore, the open link 32 is movable to an initial position and an operating position by moving together with the outside open lever 34 at each of the unlocked position and the locked position.

The open link 32 includes a release lever engagement portion 321 and a spring engagement portion 322. When the open link 32 is moved from the initial position to the operating position by the outside open lever 34 while being located at the unlocked position, the release lever engagement portion 321 engages with the release lever 31 to press the release lever 31 and move the release lever 31 from the initial position to the operating position. As a result, the lift lever engagement portion 312 of the release lever 31 engages with the lift lever 23 to press the lift lever 23 and move the lift lever 23 from the initial position to the operating position, whereby the latch mechanism 20 is switched to the unlatched state. The open link 32 is configured such that the release lever engagement portion 321 does not engage with (come into contact with) the release lever 31 when the open link 32 moves from the initial position to the operating position while being located at the locked position. Therefore, in a state where the open link 32 is located at the locked position, the latch mechanism 20 cannot be switched to the unlatched state. The spring engagement portion 322 is a protrusion that protrudes in a direction parallel to an axial direction of a rotation axis of the open link 32 with respect to the outside open lever 34. An open link biasing spring 33 is engaged with the spring engagement portion 322.

The outside open lever 34 is supported rotatably with respect to the housing, and is selectively movable to an initial position and an operating position by rotation. The outside open lever 34 is biased to the initial position by an outside open lever biasing spring 343. The outside open lever 34 is linked with the outside door handle 5 of the door 1. When the outside door handle 5 is manually operated, the outside open lever 34 moves from the initial position to the operating position in conjunction with the outside door handle 5. The outside open lever 34 includes an inside lever engagement portion 341 and an open link support portion 342. The open link support portion 342 is a portion that rotatably supports the open link 32.

The inside lever 35 is supported rotatably with respect to the housing, and is selectively movable to an initial position and an operating position by rotation. The inside lever 35 includes an inside open lever engagement portion 351 and an outside open lever engagement portion 352. The outside open lever engagement portion 352 is a portion configured to be engageable with and disengageable from the inside lever engagement portion 341 of the outside open lever 34. When the inside lever 35 moves from the initial position to the operating position, the outside open lever engagement portion 352 engages with the inside lever engagement portion 341 of the outside open lever 34 to press the outside open lever 34 and move the outside open lever 34 from the initial position to the operating position.

The inside open lever 36 is supported rotatably with respect to the housing, and is selectively movable to an initial position and an operating position by rotation. The inside open lever 36 is biased to the initial position by an inside open lever biasing spring. The inside open lever 36 is linked with the inside door handle 6 of the door 1. When the inside door handle 6 is manually operated, the inside open lever 36 moves from the initial position to the operating position in conjunction with the inside door handle 6. The inside open lever 36 includes an inside lever engagement portion 361. The inside lever engagement portion 361 is a portion configured to be engageable with and disengageable from the inside open lever engagement portion 351 of the inside lever 35. When the inside open lever 36 moves from the initial position to the operating position, the inside lever engagement portion 361 engages with the inside open lever engagement portion 351 of the inside lever 35 to press the inside lever 35 and move the inside lever 35 from the initial position to the operating position.

As described above, the outside open lever 34 moves from the initial position to the operating position by the manual operation of the outside door handle 5, and the inside open lever 36 and the inside lever 35 move from the initial positions to the operating positions by sequentially moving from the initial positions to the operating positions by the manual operation of the inside door handle 6. When the outside open lever 34 moves from the initial position to the operating position in a state where the open link 32 is located at the unlocked position, the open link 32, the release lever 31, and the lift lever 23 sequentially move from the initial positions to the operating positions (see FIGS. 8 and 9), whereby the latch mechanism 20 is switched to the unlatched state. As a result, the user can open the door 1 by manually operating the outside door handle 5 or the inside door handle 6 to switch the latch mechanism 20 from the latched state to the unlatched state. On the other hand, in a state where the open link 32 is located at the locked position, the open link 32 does not come into contact (engage) with the release lever 31 even when moving to the operating position. Therefore, even when the user manually operates the outside door handle 5 or the inside door handle 6, the latch mechanism 20 cannot be switched to the unlatched state, and the door 1 cannot be opened.

The lock mechanism 40 can switch between a locked state (see FIGS. 4 and 5) and an unlocked state (see FIGS. 2 and 3). The locked state is a state in which the switching of the latch mechanism 20 to the unlatched state by the manual operation of the outside door handle 5 or the inside door handle 6 is prohibited. The unlocked state is a state in which the switching of the latch mechanism 20 to the unlatched state by the manual operation of the outside door handle 5 or the inside door handle 6 is allowed. The lock mechanism 40 includes a locking lever 41, a locking link 42, an active lever 43, and a locked state detection switch 44.

The locking lever 41 is supported rotatably with respect to the housing, and is selectively movable to an unlock corresponding position and a lock corresponding position by rotation. The locking lever 41 includes a gear portion 411 and a locking link engagement portion 412. The gear portion 411 is a fan-shaped gear portion that meshes with a worm 62 attached to a rotation shaft of the first motor 61. The locking link engagement portion 412 is formed at a position separated radially outward from the rotation center of the locking lever 41. One end of the locking link 42 is rotatably connected to the locking link engagement portion 412.

The locking link 42 is an elongated member. A cam pin engagement portion 421 is formed at an intermediate portion in a longitudinal direction of the locking link 42. The cam pin engagement portion 421 is formed to protrude in a direction orthogonal to the longitudinal direction of the locking link 42. The locking link engagement portion 412 of the locking lever 41 is rotatably connected to one end in the longitudinal direction of the locking link 42, and a locking link engagement portion 431 of the active lever 43 is rotatably connected to the other end in the longitudinal direction of the locking link 42. The locking link 42 moves in conjunction with the locking lever 41 to move to an unlock corresponding position when the locking lever 41 moves to the unlock corresponding position, and move to a lock corresponding position when the locking lever 41 moves to the lock corresponding position.

The active lever 43 is supported rotatably with respect to the housing so as to be coaxial with the inside lever 35 and independent of the inside lever 35. The active lever 43 is selectively movable to a lock corresponding position and an unlock corresponding position by moving in conjunction with the locking lever 41 through the locking link 42. The active lever 43 moves to the lock corresponding position when the locking lever 41 moves to the lock corresponding position, and moves to the unlock corresponding position when the locking lever 41 moves to the unlock corresponding position. The lock corresponding position is a position of one end of a movable range of the active lever 43, and the unlock corresponding position is a position of the other end of the movable range of the active lever 43. The active lever 43 is selectively biased to the lock corresponding position and the unlock corresponding position by a click spring (not illustrated). Specifically, the active lever 43 is biased to the lock corresponding position when located on the lock corresponding position side with respect to an intermediate position of the movable range, and is biased to the unlock corresponding position when located on the unlock corresponding position side with respect to the intermediate position of the movable range.

The active lever 43 includes the locking link engagement portion 431 and a spring attachment portion 432. The locking link engagement portion 431 is a portion to which the locking link 42 is rotatably connected. The spring attachment portion 432 is a portion to which the open link biasing spring 33 is attached. The open link biasing spring 33 holds the open link 32 at the locked position when the active lever 43 is located at the lock corresponding position, and holds the open link 32 at the unlocked position when the active lever 43 is located at the unlock corresponding position. However, even when the active lever 43 is located at the unlock corresponding position, the open link biasing spring 33 allows the open link 32 to be located at the locked position by elastic deformation. For example, the open link biasing spring 33 is a torsion coil spring having two parallel arms as illustrated in FIGS. 3 and 5, and is elastically deformable so as to open the two arms. The spring engagement portion 322 of the open link 32 is located between the two arms of the open link biasing spring 33 and protrudes in the direction parallel to the axial direction of the rotation axis of the open link 32.

The locked state detection switch 44 detects the state (locked state, unlocked state) of the lock mechanism 40. The locked state detection switch 44 is installed so as to be pressed by the locking lever 41 (see FIGS. 2 and 3) when the locking lever 41 is located at the unlock corresponding position (in the unlocked state), and such that the locking lever 41 is separated therefrom (see FIGS. 4 and 5) when the locking lever 41 is located at the lock corresponding position (in the locked state).

The first motor 61 is a drive source that drives the lock mechanism 40. The worm 62 is attached to the rotation shaft of the first motor 61. The gear portion 411 of the locking lever 41 meshes with the worm 62. In the lock mechanism 40, when the locking lever 41 moves to the lock corresponding position by a driving force of the first motor 61, the active lever 43 moving in conjunction with the locking lever 41 through the locking link 42 moves to the lock corresponding position to move the open link 32 to the locked position. In the lock mechanism 40, when the locking lever 41 moves to the unlock corresponding position by the driving force of the first motor 61, the active lever 43 moving in conjunction with the locking lever 41 through the locking link 42 moves to the unlock corresponding position to move the open link 32 to the unlocked position. As a result, the door lock device 10 can be switched between the locked state and the unlocked state by the driving force of the first motor 61. In the door lock device 10, by the manual operation of the outside door handle 5 or the inside door handle 6 when the lock mechanism 40 is in the unlocked state, the latch mechanism 20 is switched from the latched state to the unlatched state to allow the opening of the door 1. The first motor 61 and the worm 62 correspond to a first actuator of the present disclosure.

The double lock mechanism 50 is switchable between a double lock set state (see FIGS. 6 and 7) and a double lock unset state (see FIGS. 4 and 5) when the lock mechanism 40 is in the locked state. The double lock set state is a state in which the switching of the lock mechanism 40 to the unlocked state is prohibited. The double lock unset state is a state in which the switching of the lock mechanism 40 to the unlocked state is allowed. The double lock mechanism 50 includes a push-type cam mechanism that alternately switches between the double lock set state and the double lock unset state by a pushing operation in the same direction.

The double lock mechanism 50 (push-type cam mechanism) includes a pin 51, an outer cylinder 52, an inner cylinder 53, and a pin biasing spring (not illustrated). The pin 51 is an elongated rod-shaped member. A pin cam portion (not illustrated) is formed on an outer peripheral surface of the pin 51. The pin cam portion is a ridge extending in an axial direction. The pin 51 is inserted into the outer cylinder 52 and the inner cylinder 53 such that its intermediate portion is covered and its front end portion and rear end portion are exposed, and the pin 51 is rotatable with respect to the outer cylinder 52 and the inner cylinder 53 and movable in the axial direction. The pin 51 is selectively movable to a protruding position and a retracted position by moving in the axial direction. The protruding position is a position where the pin 51 moves forward (in a direction from the rear end toward the front end). The retracted position is a position where the pin 51 moves rearward (in a direction from the front end to the rear end). Furthermore, the pin 51 is biased forward in the axial direction with respect to the outer cylinder 52 by the pin biasing spring. An outer cylinder cam portion (not illustrated) is formed on an inner peripheral surface of the outer cylinder 52. The outer cylinder cam portion has a plurality of cam teeth and cam grooves alternately formed in a circumferential direction. The pin 51 is held at the protruding position by the pin cam portion engaging with the cam groove of the outer cylinder cam portion, and is held at the retracted position by the pin cam portion engaging with the cam tooth of the outer cylinder cam portion. The inner cylinder 53 is a push member inserted into the outer cylinder 52, and is movable in the axial direction with respect to the outer cylinder 52. The inner cylinder 53 is movable to a non-switch position and a switch position by moving in the axial direction. An inner cylinder cam portion (not illustrated) is formed on an end surface of the inner cylinder 53 facing the pin cam portion. The inner cylinder cam portion is a cam surface having a plurality of crest portions and trough portions alternately formed in the circumferential direction. When the inner cylinder 53 moves from the non-switch position to the switch position, the inner cylinder cam portion presses the pin cam portion of the pin 51 with the cam surface against a biasing force of the pin biasing spring, and rotates the pin 51 while pressing the pin 51 rearward. A cam arm 531 is formed on an outer peripheral surface of the inner cylinder 53. The cam arm 531 is a tongue-shaped portion protruding in a direction orthogonal to the axial direction of the inner cylinder 53.

As illustrated in FIG. 11, in the double lock mechanism 50, the cam arm 531 is pressed so as to move the inner cylinder 53 from the non-switch position to the switch position by rotating the rotating member 73 clockwise in the drawing, whereby the cam surface of the inner cylinder cam portion engages with the pin cam portion to rotate the pin 51 while pressing the pin 51 rearward. The pressing of the cam arm 531 is released to return the inner cylinder 53 from the switch position to the non-switch position, and the pin 51 moves forward by the biasing force of the pin biasing spring, whereby the pin cam portion engages with the cam tooth or the cam groove of the outer cylinder cam portion of the outer cylinder 52. As a result, every time the cam arm 531 is operated and released, the pin cam portion alternately engages with the cam tooth and the cam groove, and the pin 51 can be alternately switched between the protruding position and the retracted position.

In the double lock mechanism 50, when the pin 51 moves to the protruding position in a state where the locking link 42 of the lock mechanism 40 is located at the lock corresponding position, the pin 51 engages with the cam pin engagement portion 421 of the locking link 42, to restrict the movement of the locking link 42 from the lock corresponding position to the unlock corresponding position (see FIGS. 6 and 7). As a result, the switching of the lock mechanism 40 to the unlocked state is prohibited (double lock set state). On the other hand, when the pin 51 moves to the retracted position, the double lock mechanism 50 releases the engagement of the pin 51 with the cam pin engagement portion 421, to allow the movement of the locking link 42 from the lock corresponding position to the unlock corresponding position (see FIGS. 4 and 5). As a result, the switching of the lock mechanism 40 to the unlocked state is allowed (double lock unset state).

A double-locked state detection switch 54 detects the state (double lock set state, double lock unset state) of the double lock mechanism 50. The double-locked state detection switch 54 is installed so as to be pressed by the pin 51 (see FIGS. 4 and 5) when the pin 51 is located at the retracted position (in the double lock unset state), and such that the pin 51 is separated therefrom (see FIGS. 6 and 7) when the pin 51 is located at the protruding position (in the double lock set state).

The second motor 71 is a drive source of the rotating member 73. A worm 72 is attached to a rotation shaft of the second motor 71. The rotating member 73 configured as a worm wheel meshes with the worm 72. The second motor 71 can drive the rotating member 73 in both forward and reverse rotation directions.

The rotating member 73 is rotationally driven by the second motor 71 to be movable to a neutral position, an unlatch corresponding position, and a cam motion position. The neutral position is an intermediate position of a movable range of the rotating member 73. The unlatch corresponding position is a position of one end of the movable range of the rotating member 73. The cam motion position is a position of the other end of the movable range of the rotating member 73. The rotating member 73 includes a release lever engagement portion 731 and a cam engagement portion 732. The release lever engagement portion 731 is configured to be engageable with and disengageable from the rotating member engagement portion 311 of the release lever 31. The rotating member engagement portion 311 of the release lever 31 is in contact with the release lever engagement portion 731 of the rotating member 73 when the rotating member 73 is at a rotational position between the neutral position and the unlatch corresponding position, and is not in contact with the release lever engagement portion 731 when the rotating member 73 is at a rotational position between the neutral position and the cam motion position. The cam engagement portion 732 is configured to be engageable with and disengageable from the cam arm 531 of the double lock mechanism 50. The cam arm 531 is in contact with the cam engagement portion 732 of the rotating member 73 when the rotating member 73 is at the rotational position between the neutral position and the cam motion position, and is not in contact with the cam engagement portion 732 when the rotating member 73 is at the rotational position between the neutral position and the unlatch corresponding position.

Therefore, as illustrated in FIGS. 12 and 13, by rotationally driving the rotating member 73 in one direction (clockwise in FIG. 12) by the second motor 71 to move the rotating member 73 from the neutral position to the unlatch corresponding position, the release lever engagement portion 731 of the rotating member 73 engages with the rotating member engagement portion 311 of the release lever 31 to press the release lever 31 and move the release lever 31 to the operating position. When the release lever 31 is moved to the operating position, the lift lever engagement portion 312 of the release lever 31 engages with the lift lever 23 to press the lift lever 23 and move the lift lever 23 to the operating position, whereby the latch mechanism 20 is switched to the unlatched state. Since the rotating member 73 directly presses the release lever 31 without the open link 32 interposed therebetween, the latch mechanism 20 can be switched to the unlatched state by the second motor 71 regardless of the state of the lock mechanism 40 and the state of the double lock mechanism 50. The second motor 71, the worm 72, and the rotating member 73 (the release lever engagement portion 731) correspond to a second actuator of the present disclosure.

As illustrated in FIGS. 10 and 11, by rotationally driving the rotating member 73 in a direction (clockwise in FIG. 11) opposite to the one direction by the second motor 71 to move the rotating member 73 from the neutral position to the cam motion position, the cam engagement portion 732 of the rotating member 73 engages with the cam arm 531 of the double lock mechanism 50 to press the cam arm 531 and move the inner cylinder 53 (push member) from the non-switch position to the switch position. The double lock mechanism 50 can be alternately switched between the double lock set state and the double lock unset state every time the operation of moving the rotating member 73 from the neutral position to the cam motion position by a driving force in the opposite direction of the second motor 71 and returning the rotating member 73 to the neutral position by a biasing force of a rotating member biasing spring is executed. The second motor 71, the worm 72, and the rotating member 73 (the cam engagement portion 732) correspond to a third actuator of the present disclosure.

The door lock device 10 includes a key lever 45, a key switch lever 46, and a key crank 47. The key lever 45 is rotatable integrally with an inner cylinder (plug) of a key cylinder by operating the key cylinder. The key switch lever 46 is rotatable with respect to the housing, and is movable to a neutral position, an unlock operation position, and a lock operation position in conjunction with the key lever 45. As a result, the key switch lever 46 moves from the neutral position to the unlock operation position or the lock operation position in conjunction with the operation of the key cylinder. The neutral position is an intermediate position of a movable range of the key switch lever 46. The unlock operation position is a position rotated in one direction from the neutral position. The lock operation position is a position rotated in a direction opposite to the one direction from the neutral position.

The key crank 47 is supported rotatably with respect to the housing, and is selectively movable between an initial position and an operating position by rotation. When the key switch lever 46 moves from the neutral position to the unlock operation position, the key crank 47 is pressed by the key switch lever 46 to be moved from the initial position to the operating position. When the key crank 47 is moved to the operating position, the key crank 47 presses the cam arm 531 to move the inner cylinder 53 from the non-switch position to the switch position. Therefore, in a case where the double lock mechanism 50 is in the double lock set state, the double lock mechanism 50 can be switched to the double lock unset state by operating the key cylinder. As a result, for example, even if the double lock cannot be released by the second motor 71 due to, for example, a battery of the vehicle going flat, the double lock can be urgently released manually.

As illustrated in FIG. 14, the control device 80 is configured as a microprocessor centered on a CPU 81, and includes a ROM 82 that stores a processing program, a RAM 83 that temporarily stores data, an input/output port, a communication port, and the like in addition to the CPU 81. The control device 80 receives signals from various switches such as the locked state detection switch 44 and the double-locked state detection switch 54. The control device 80 also receives a signal from a door opening/closing switch 91 and a signal from a wireless remote control key 92 configured as a so-called smart key. The door opening/closing switch 91 is a switch for ordering opening/closing of the door 1 by a user's operation, and is installed at the outside door handle 5 or on the outer panel 4 near the outside door handle 5. The door opening/closing switch 91 may be a push-button switch or a touch switch. The door opening/closing switch 91 may be a sensor that detects a handle operation of the outside door handle 5. The remote control key 92 can lock and unlock the door 1 and set and release the double lock by remote operation. The control device 80 outputs a drive signal to the first motor 61 and the second motor 71.

Next, an operation of the door lock device 10 configured as described above according to the present embodiment will be described. In particular, an operation when an opening operation of the door 1 from the double lock set state is detected will be described.

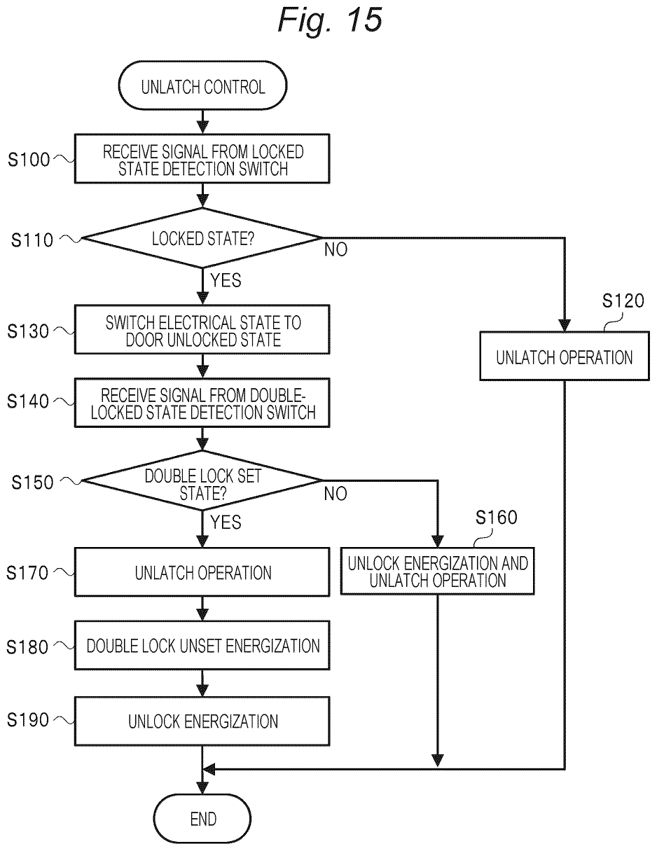

FIG. 15 is a flowchart illustrating an example of an unlatch control routine executed by the CPU 81 of the control device 80. This routine is executed when user authentication is completed by collating a key-side ID transmitted from the remote control key 92 carried by the user with a stored vehicle-side ID, and the opening operation of the door 1 by the user is detected by the door opening/closing switch 91.

When the unlatch control routine is executed, the CPU 81 of the control device 80 first receives a signal from the locked state detection switch 44 (step S100), and determines whether the lock mechanism 40 is in the locked state (step S110). If determining that the lock mechanism 40 is not in the locked state but in the unlocked state, the CPU 81 performs drive control (unlatch operation) of the second motor 71 so as to switch the latch mechanism 20 to the unlatched state (step S120), and ends this routine.

On the other hand, if determining that the lock mechanism 40 is in the locked state at step S110, the CPU 81 switches the electrical state to the unlocked state (step S130). Next, the CPU 81 receives a signal from the double-locked state detection switch 54 (step S140), and determines whether the double lock mechanism 50 is in the double lock set state (step S150). If determining that the double lock mechanism 50 is not in the double lock set state but in the double lock unset state, the CPU 81 performs drive control (unlock energization) of the first motor 61 so as to switch the lock mechanism 40 to the unlocked state and performs drive control (unlatch operation) of the second motor 71 so as to switch the latch mechanism 20 to the unlatched state (step S160), and ends this routine. In the present embodiment, the first motor 61 and the second motor 71 are simultaneously driven so as to simultaneously perform the unlock energization and the unlatch operation. This makes it possible to quickly perform the switching to the unlocked state and the switching to the unlatched state. At step S160, the CPU 81 may perform the unlatch operation after performing the unlock energization, or may perform the unlock energization after performing the unlatch operation.

If determining that the double lock mechanism 50 is in the double lock set state at step S150, the CPU 81 first performs drive control (unlatch operation) of the second motor 71 so as to switch the latch mechanism 20 to the unlatched state (step S170). After switching the latch mechanism 20 to the unlatched state, the CPU 81 performs drive control (double lock unset energization) of the second motor 71 in the reverse rotation direction so as to switch the double lock mechanism 50 to the double lock unset state (step S180), performs drive control (unlock energization) of the first motor 61 so as to switch the lock mechanism 40 to the unlocked state (step S190), and ends this routine.

As described above, since the door lock device 10 of the present embodiment requires the user to perform the opening operation of the door 1 to release the double lock set state (switch to the double lock unset state), it is possible to prevent unintentional release of the double lock set state. Since the latch mechanism 20 is first switched to the unlatched state by the opening operation of the door 1 by the authenticated user, it is possible to secure favorable responsiveness to the opening operation of the door 1. Furthermore, the double lock mechanism 50 is configured to alternately switch between the double lock set state and the double lock unset state by the pushing operation, and the switching to the double lock unset state and the switching to the unlatched state are performed by the single motor (the second motor 71), so that the manufacturing cost can be further reduced by reducing the number of components.

It should be noted that the present disclosure is not limited to the above-described embodiment at all, and it goes without saying that the present disclosure can be implemented in various modes as long as it falls within the technical scope of the present disclosure.

For example, in the above-described embodiment, the first motor 61 is used to drive the lock mechanism 40, and the second motor 71 is used to drive both the latch mechanism 20 and the double lock mechanism 50. However, the first motor 61 may be used to drive both the lock mechanism 40 and the double lock mechanism 50, and the second motor 71 may be used to drive the latch mechanism 20. Alternatively, different motors may be used for driving the latch mechanism 20, driving the lock mechanism 40, and driving the double lock mechanism 50.

The present disclosure is applicable to, for example, the manufacturing industry of the door lock device.

(1) A door lock device for a vehicle, the door lock device includes:
a latch mechanism configured to selectively form a latched state in which a door is held in a closed state, and an unlatched state in which opening of the door is allowed;
a lock mechanism configured to selectively form a locked state in which switching of the latch mechanism to the unlatched state by manual operation is prohibited, and an unlocked state in which the switching of the latch mechanism to the unlatched state by manual operation is allowed;
a double lock mechanism configured to selectively form a double lock set state in which switching of the lock mechanism to the unlocked state is prohibited, and a double lock unset state in which the switching of the lock mechanism to the unlocked state is allowed;
a first actuator configured to electrically switch the lock mechanism to the unlocked state;
a second actuator configured to electrically switch the latch mechanism to the unlatched state regardless of a state of the lock mechanism and a state of the double lock mechanism;
a third actuator configured to electrically switch the double lock mechanism to the double lock unset state; and
a control device configured to control the first actuator, the second actuator, and the third actuator to switch the double lock mechanism to the double lock unset state and switch the lock mechanism to the unlocked state after switching the latch mechanism to the unlatched state upon detecting an opening operation of the door by an authenticated operator when the lock mechanism is in the locked state and the double lock mechanism is in the double lock set state.

The door lock device of the present disclosure includes the actuator (second actuator) that electrically switches the latch mechanism to the unlatched state regardless of the state of the lock mechanism and the state of the double lock mechanism. In the door lock device of the present disclosure, upon detecting the opening operation of the door by the authenticated operator when the lock mechanism is in the locked state and the double lock mechanism is in the double lock set state, the latch mechanism is first switched to the unlatched state, and then the double lock mechanism is switched to the double lock unset state and the lock mechanism is switched to the unlocked state. Since the opening operation of the door by the operator is required to release the double lock set state, it is possible to prevent unintentional release of the double lock set state. Since the latch mechanism is first switched to the unlatched state by the opening operation of the door by the authenticated operator, it is possible to secure favorable responsiveness to the opening operation of the door.
(2) In the door lock device, the first actuator switches the lock mechanism to the unlocked state by a driving force of a first motor, the second actuator switches the latch mechanism to the unlatched state by a driving force of a second motor different from the first motor, and the third actuator switches the double lock mechanism to the double lock unset state by a driving force in a reverse direction of the second motor.
(3) In the door lock device, the control device controls the first motor and the second motor to simultaneously perform the switching of the latch mechanism to the unlatched state and the switching of the lock mechanism to the unlocked state upon detecting the opening operation of the door by the authenticated operator when the lock mechanism is in the locked state and the double lock mechanism is in the double lock unset state.
(4) In the door lock device, the double lock mechanism is configured to alternately switch between the double lock set state and the double lock unset state by the driving force in the reverse direction of the second motor.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door lock device for a vehicle, the door lock device comprising:
a latch mechanism configured to selectively form a latched state in which a door is held in a closed state, and an unlatched state in which opening of the door is allowed;
a lock mechanism configured to selectively form a locked state in which switching of the latch mechanism to the unlatched state by manual operation is prohibited, and an unlocked state in which the switching of the latch mechanism to the unlatched state by manual operation is allowed;
a double lock mechanism configured to selectively form a double lock set state in which switching of the lock mechanism to the unlocked state is prohibited, and a double lock unset state in which the switching of the lock mechanism to the unlocked state is allowed;
a first actuator configured to electrically switch the lock mechanism to the unlocked state;
a second actuator configured to electrically switch the latch mechanism to the unlatched state regardless of a state of the lock mechanism and a state of the double lock mechanism;
a third actuator configured to electrically switch the double lock mechanism to the double lock unset state; and
a control device configured to control the first actuator, the second actuator, and the third actuator to switch the double lock mechanism to the double lock unset state and switch the lock mechanism to the unlocked state after switching the latch mechanism to the unlatched state upon detecting an opening operation of the door by an authenticated operator when the lock mechanism is in the locked state and the double lock mechanism is in the double lock set state.

2. The door lock device according to claim 1, wherein
the first actuator switches the lock mechanism to the unlocked state by a driving force of a first motor,
the second actuator switches the latch mechanism to the unlatched state by a driving force of a second motor different from the first motor, and
the third actuator switches the double lock mechanism to the double lock unset state by a driving force in a reverse direction of the second motor.

3. The door lock device according to claim 2, wherein
the control device controls the first motor and the second motor to simultaneously perform the switching of the latch mechanism to the unlatched state and the switching of the lock mechanism to the unlocked state upon detecting the opening operation of the door by the authenticated operator when the lock mechanism is in the locked state and the double lock mechanism is in the double lock unset state.

4. The door lock device according to claim 2, wherein
the double lock mechanism is configured to alternately switch between the double lock set state and the double lock unset state by the driving force in the reverse direction of the second motor.

5. The door lock device according to claim 3, wherein
the double lock mechanism is configured to alternately switch between the double lock set state and the double lock unset state by the driving force in the reverse direction of the second motor.
